(19) United States
(12) Patent Application Publication
(10) Pub. No.: US 2016/0140533 A1
(43) Pub. Date: May 19, 2016

(54) System and Method for Assessing and Collecting Taxes for Motor Vehicle Fuel at the Point of Sale

(71) Applicants: Matthew W. Milligan, Dallas, TX (US); Tyler K. Milligan, Carrollton, TX (US)

(72) Inventors: Matthew W. Milligan, Dallas, TX (US); Tyler K. Milligan, Carrollton, TX (US)

(21) Appl. No.: 14/851,770

(22) Filed: Sep. 11, 2015

Related U.S. Application Data
(60) Provisional application No. 62/049,896, filed on Sep. 12, 2014.

(51) Int. Cl. G06Q 20/20; G06Q 50/06; G06Q 30/02

(52) U.S. Cl. CPC G06Q 20/207; G06Q 30/0283; G06Q 50/06

(57) ABSTRACT

A system and method for assessing and collecting taxes for fuel for motor vehicles at the point of sale through use of a vehicle identification device; a reader or scanner to receive and process information received or obtained from the vehicle identification device; a tax rate and price determination controller that can determine an appropriate tax rate to be added to a base fuel price; a dispensing device configured to dispense motor fuel to an identified vehicle and track the quantity of motor fuel dispensed; a payment processor that can determine a total purchase price having at least a base fuel price component and at least one fuel tax component, and execute a payment transaction for a particular method of payment; and a payment distribution controller that can allocate portions of the total purchase price to an identified account and execute or report such distributions.

### FIELD OF THE INVENTION

This invention relates to a system and method whereby fuel-related taxes for motor vehicles are assessed and collected at the point of sale.

### DESCRIPTION OF RELATED ART

Since 1993, the United States federal excise tax on gasoline has been 18.4 cents per gallon and 24.4 cents per gallon for diesel fuel. Taxes on gasoline are also imposed by the states. On average, as of April 2014, state and local taxes add 31.5 cents to gasoline and 31.0 cents to diesel, for a total US average fuel tax of 49.9 cents per gallon for gas and 55.4 cents per gallon for diesel. A majority of the federal gasoline tax revenue is used for bridge and road building, and the remainder is typically earmarked for other purposes.

At the Federal level, the majority of the taxes are collected when product is removed from the bulk storage terminals. The companies pay the tax to the Internal Revenue Service (IRS) and the money is deposited into the federal Highway Trust Fund, which comprises several different accounts for various end use purposes. The states within the United States have different rules for the point of taxation. Some states tax the product “at the rack,” which is upon removal from the bulk terminal, while other states impose the tax at the distributor level, having a series of approved bulk distributors, who hold licenses and file regular (usually monthly) returns where the state and local taxes are paid.

The United States is currently experiencing gasoline tax revenue shortages in relation to the demand for funds needed to maintain or improve the quality of the highways and bridges that are part of our ever-expanding network of roadways. Without additional revenues, the public roadways are likely to become more clogged, less safe, and less effective for use both by businesses and by individual consumers. These revenue shortfalls have prompted state legislatures to consider alternatives for financing of bridge and road infrastructure. Some pilot programs are presently being tested for possible use as alternatives to replace the federal gas tax. In California, a “vehicle miles traveled” (“VMT”) program is using a device installed in the vehicle to track the mileage driven with a charge of five cents per mile. In Oregon, drivers have volunteered to have mileage readers installed in their vehicles. More than 18 other states are also considering these types of programs to address the financial shortfall.

Substituting a VMT tax structure for the existing federal and state gasoline taxes offers advantages to consumers and promotes environmental consciousness while also potentially providing increased fuel tax revenues to the federal government and the states. However, changing the method of assessing and collecting fuel taxes, particularly to a system where the taxes are collected at the “point of sale” (“POS”), also poses challenges in regard to consumer privacy, security and ease of use. A system and method for assessing gasoline-related taxes based upon either actual or inferred VMT and for collecting gasoline-related taxes at the POS are now disclosed.

### SUMMARY OF THE INVENTION

Assessing and collecting a tax for a motor vehicle fuel such as gasoline at the point of sale is believed to be an effective way to fund a large network of roadways using an existing point of sale infrastructure built upon the supply of fuel to motor vehicles. One approach, perhaps the simplest, is to set the tax as a flat number of cents per gallon and calibrate gasoline dispensing pumps to add that amount per gallon to a current “base price” for the particular grade of gasoline, and then remit the tax portion of the tax to the relevant federal or state taxing authorities according to predetermined reporting procedures when the purchase transaction is executed at the point of sale. As to the federal gasoline tax, this approach simply shifts the collection point but does not allow various tax rates to be imposed for different vehicles according to other relevant parameters.

Another approach is similar to the first, but also can take into consideration other factors such as, for example, the type of vehicle being driven, the geographical location of the point of sale, the type of fuel being purchased, etc. to set different fuel tax rates for different vehicles. One way to implement this is to establish tax tables that assign a particular rate code to each vehicle or purchase and provide an appropriate multiplier for each rate code to determine the amount of fuel tax to be added to the base price of the fuel. With a system and method of the invention configured in this way, various tax rates can be applied to different classes or categories of vehicles as a matter of policy to encourage or discourage certain behaviors rather than simply tying the fuel tax to the number of miles driven. Such behaviors can include, for example and without limitation, driving environmentally friendly vehicles; driving vehicles that cause less wear-and-tear on roads; driving in locations where the roadways or operating conditions are more maintenance-intensive; refueling at particular times or locations, and the like.

Still another approach is to charge the base price for each gallon of gasoline dispensed and then calculate an amount of tax based upon either the actual miles driven (“actual VMT”) or a VMT number that is inferred (“inferred VMT”) or determined from the quantity of fuel (e.g., gallons of gasoline) dispensed and the rated fuel efficiency (e.g., miles per gallon) of that vehicle. Using an inferred VMT makes the system less complex and alleviates privacy concerns associated with tracking actual miles driven for a particular vehicle and reporting that information every time that fuel is purchased.

The system and method disclosed here are useful for implementing any of the foregoing approaches but will desirably include a capability for assigning different tax rates to different vehicles based upon factors that are considered to be economically, environmentally or politically desirable. Although not required, a vehicle identification card (“VID”) is desirably used in conjunction with the system and method of the invention. Depending upon the configuration of a particular system, the VID can be used, for example and without limitation, to validate a particular user or vehicle, facilitate the transfer of information needed to determine an appropriate fuel tax rate, authorize use of a previously determined and assigned tax rate code, and/or to track total fuel taxes paid in relation to a particular user or vehicle. In more complex systems, information encoded on a VID can also be used to adjust the base price of fuel for a particular user, class of vehicle, or other predetermined parameter. Alternatively, where a VID is not used or available, a system of the invention can be configured to accept equivalent data that is entered manually, such as through a keypad, or to default to a default tax rate that is probably higher than would have been available to a user having a VID.

Each system of the invention will desirably include a reader or scanner to receive and interpret information received or obtained from the VID, a tax rate and price determination controller that can determine the appropriate tax rate and fuel price for a particular vehicle and transaction, a dispensing device such as a gasoline pump that can dispense fuel to a vehicle and track the quantity of fuel dispensed, a payment processor that can execute a transaction for a particular method of payment, and a payment distribution controller that can allocate portions of the purchase price to an identified account and execute or report such distributions in relation to fuel dispensed at a POS. If desired, all of the foregoing elements of the subject system except the VID can be incorporated into a single fuel dispensing device or into devices located at the POS.

Optionally, a separate VMT data source can also be included as part of, or be linked to, the system of the invention. Where a fuel tax assessment and collection program is based upon actual VMT, the system could also include a mileage tracking module internal to the vehicle and a data transfer component that can receive or download vehicle mileage data as part of a fuel purchase transaction. Where a fuel tax assessment and collection program is at least partially based upon inferred VMT, a VMT data source is not needed, as an inferred VMT can be calculated from the quantity of fuel dispensed and fuel efficiency ratings that are either encoded on the VID, pre-loaded into one of the tax rate determination controller, fuel dispenser and payment processor, or accessible through an electronic link to a database containing that information.

As another part of the present invention, a method is also disclosed through which the system of the invention can be used to execute a fuel purchase transaction in which a fuel tax rate is determined and is applied at a POS to calculate a total fuel purchase price that is then collected at the POS, after which the tax portion of the total purchase price is distributed to one or more identified accounts and reported in accordance with predetermined parameters and procedures. If desired, the subject method can incorporate the step of sourcing actual VMT data or calculating inferred VMT data that can be used in determining the rate and/or amount of fuel tax paid.

Although the system and method of the invention are principally disclosed here for use in determining, assessing and collecting federal and/or state taxes on gasoline, it will be appreciated by those of skill in the art upon reading this disclosure that the same or a similarly configured system and method can be used to tax other vehicular fuels at the POS. Thus, for example and without limitation, the assessment and collection of taxes or other payments for diesel fuel, compressed natural gas, propane, electricity for recharging batteries, and the like, can all be implemented if desired using the system and method of the invention.

Various embodiments of the system and method of the invention can utilize, include or take advantage of certain elements and components that are already existing, such as, for example, existing infrastructure and points of sale, funds handling and distribution networks already in place, fuel handling and distribution systems already being utilized, and the like. Those embodiments of the invention will desirably also include other elements not present in the prior art distribution systems and methods used for distributing gasoline and other motor vehicle fuels.

As mentioned above, some systems and methods of the invention will also desirably utilize vehicle identification devices (“VID”) that can readily read, scan or download and process information such as user identity, vehicle identification number (“VIN”) or, in some cases, VMT data. Some systems and methods of the invention can automatically distribute VMT or tax data to state agencies and/or to the U.S. Department of Transportation (“DOT”). Some systems and methods of the invention can be configured to automatically forward transactional information or funds to appropriate federal agencies or accounts. Some systems and methods of the invention can be configured for use in third party gift distribution systems; and the like.

At least some embodiments of the system and method of the invention will require or optionally include new elements, features and processes such as, for example, links to other databases or resources such as the website www.fueleconomy.gov for information concerning independent tests of vehicle fuel economy, or databases from which motor vehicle and owner identification information can be ascertained and verified.

Regardless of the particular embodiment of the invention that is selected for use in a particular application, or for a particular state or geographical locale, principal features of the invention are the capabilities for assessing and collecting a vehicle fuel tax at a gas pump or cash register disposed at the POS as part of a typical fuel purchase transaction.

VMT-based fuel tax systems can, but do not necessarily involve tracking a user's path across a defined geographical territory The technology needed to do this is already available, and can, for example, selectively include the of global positioning systems (“GPS”), Wi-Fi hotspots, cellular tower triangulation, gyroscopic/altimeter/accelerometer data, or a combination of some or all of these. However, concerns about collecting and reporting mileage and other driving data for individual users or vehicles directly to a governmental entity and also linking that data to financial information for the same user. Those concerns predictably relate to issues such as how reliably the data be secured, how the identities and financial information of individual users can be protected, and what uses of the data are permitted—all while still reliably tracking and reporting vehicle movement for purposes of levying and collecting taxes. These and other concerns are satisfactorily addressed in the system and method disclosed here by basing the vehicle fuel tax on inferred rather than actual VMT.

The system and method of the invention will provide a closer tie between vehicle travel and the funding and maintenance of roadway infrastructure and services and can be readily modified for optional use or to include ancillary enhancements, capabilities and benefits such as, for example, providing a third-party gift card distribution component. These and other features, benefits and advantages of the subject invention are further illustrated, described, explained and claimed below.

### BRIEF DESCRIPTION OF THE DRAWINGS

The system and method of the invention are further described and explained in relation to the following drawings wherein:

FIG. 1 is a simplified diagrammatic view of one embodiment of the system for assessing and collecting a tax on motor vehicle fuel at the point of sale;

FIG. 2 is a simplified diagrammatic view of one embodiment of the method of the invention in a progression that exemplifies a fuel purchase transaction;

FIG. 3A is a simplified diagrammatic view of the first of three sequential portions (including FIGS. 3A, 3B, 3C, respectively) that collectively illustrate another embodiment of the method of the invention in a progression that, when viewed from left to right, respectively, exemplifies a fuel purchase transaction, wherein “circled A” and “circled B” are match points designating the points of connection between FIG. 3A and FIG. 3B;

FIG. 3B is a simplified diagrammatic view of the second of three sequential portions (including FIGS. 3A, 3B, 3C, respectively) that collectively illustrate an embodiment of the method of the invention in a progression that, when viewed from left to right, respectively, exemplifies a fuel purchase transaction, wherein “circled A” and “circled B” are match points designating points of connection between FIG. 3A and FIG. 3B, and wherein “circled C” and “circled D” are match points designating points of connection between FIG. 3B and FIG. 3C;

FIG. 3C is a simplified diagrammatic view of the third of three sequential portions (including FIGS. 3A, 3B, 3C, respectively) that collectively illustrate an embodiment of the method of the invention in a progression that, when viewed from left to right, respectively, exemplifies a fuel purchase transaction, wherein “circled C” and “circled D” are match points designating points of connection between FIG. 3B and FIG. 3C;

FIG. 4A is a simplified diagrammatic view of the first of two sequential portions (including FIGS. 4A and 4B, respectively) that collectively illustrate, when viewed from left to right, respectively, a method wherein an annual inspection is used as a reference point at which a VID is issued, updated or certified, that verifies the vehicle, owner and mileage and can optionally be used to link multiple vehicles for purposes of fuel purchase transactions, and wherein “circled E” and “circled F” are match points designating points of connection between FIG. 4A and FIG. 4B; and

FIG. 4B is a simplified diagrammatic view of the second of two sequential portions (including FIGS. 4A and 4B, respectively) that collectively illustrate, when viewed from left to right, respectively, a method wherein an annual inspection is used as a reference point at which a VIS is issued, updated or certified, that verifies the vehicle, owner and mileage and can optionally be used to link multiple vehicles for purposes of fuel purchase transactions, and wherein “circled E” and “circled F” are match points designating points of connection between FIG. 4A and FIG. 4B.

### DESCRIPTION OF PREFERRED EMBODIMENTS

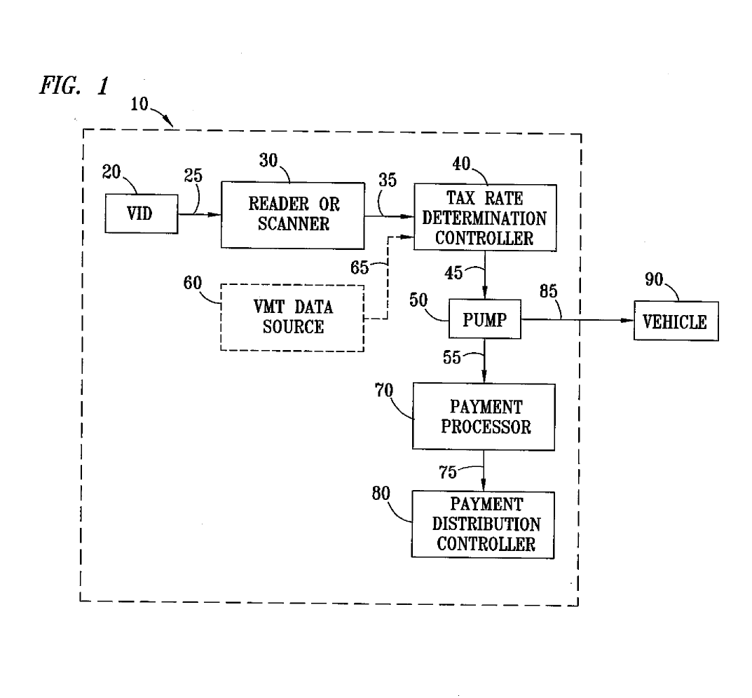

Referring to FIG. 1, an embodiment of system 10 of the invention is disclosed that comprises vehicle identification device 20, reader or scanner 30, tax rate determination controller 40, fuel dispensing device 50 (shown here as a pump), payment processor 70 and payment distribution controller 80. VMT data source 60 is an optional component for use in systems of the invention wherein vehicle miles traveled enter into the computation of the fuel tax owed by an identified vehicle. Vehicle 90 is depicted outside the dashed box defining the boundary of this embodiment of system 10 because the vehicle itself is not necessarily part of the system of the invention.

System 10 is depicted as being bounded by a dashed outline that can for some embodiments of the invention be considered to be an indication of the point of sale. It should be appreciated, however, that the physical boundaries of system 10 can vary widely within the scope of the invention. In some embodiments of the invention, every element depicted inside system 10 can be disposed in a single gasoline pump. In other embodiments of the invention, some elements of system 10 can be disposed at the vehicle fuel pump, others can be disposed inside a gas station or convenience store associated with the vehicle fuel pump, or even at another offsite location. For example, the vehicle identity can be determined at the fuel pump, payment can be processed at the pump or inside an associated office or store, and payments can be distributed from an offsite location located many miles away, or perhaps in another state.

During use of system 10 in accordance with one satisfactory embodiment of the method of the invention, users will need to acquire a VID 20, typically a card comprising a magnetic stripe or electronic chip comprising encoded information including, for example, the vehicle identification number (“VIN”) and such other supplemental information as may be required. Such supplemental information could include, for example, the vehicle owner's name, address, driver license number, vehicle inspection certification and insurance certification and carrier. VID 20 is desirably issued by a designated state or federal agency, or by authorized service providers who are licensed to issue VIDs. According to another embodiment of the invention, a vehicle owner is assigned a fuel purchase authorization number after registering with the DMV, DOL, or state vehicle registration facility, and then enters the authorization number on a keypad at a POS. According to yet another embodiment of the invention, a vehicle is equipped with a VID 20 in the form of an electronic chip that can be read by a scanner or reader 30 whenever a motor vehicle is parked beside a fuel dispenser or, for example, when the nozzle of a gas pump is inserted into the refueling spout of a motor vehicle parked at a POS. If desired, a tax rate code for a particular vehicle can be assigned at the time the vehicle is registered for use with a tax assessment and collection system 10, or can be applied (or overridden) by tax rate determination controller 40 under appropriate circumstances.

Where VID 20 is a card, it can be scanned or swiped as indicated by arrow 25 in FIG. 1 at a fuel dispensing pump 50 or another identified location at the POS to initiate a fuel purchase transaction. For this purpose, a reader or scanner 30 is desirably provided, and is linked either directly or remotely to tax rate determination controller 40, as indicated by arrow 35 in FIG. 1. If desired, tax rate controller 40 can be integrated into a programmable logic controller (“PLC”) or other central processing unit (“CPU”) that can also be programmed to perform other functions associated with system 10 and the method of the invention.

The tax rate determination controller 40 desirably determines an appropriate fuel tax rate to be applied to a particular vehicle, either from data entered from the scanner or reader 30 or otherwise input into system 10 from tables programmed into controller 40, and desirably forwards the fuel tax rate (or code) to pump 50 as indicated by arrow 45 in FIG. 1. If desired, controller 40 can also determine a fuel tax rate for an identified vehicle 90 based wholly or in part on information received as indicated by arrow 65 in FIG. 1 from an optionally provided VMT data source 60. Where fuel tax assessment and collection system 10 of the invention is configured to assess the fuel tax according to a protocol that takes into consideration the actual VMT over a given time increment (such as, for example, the elapsed time since the last prior fuel purchase), VMT data source 60 can desirably determine either the actual VMT or current mileage from a “sender” disposed in vehicle 90. Where VMT data source 60 simply captures the current mileage reading for vehicle 90, the actual VMT can determined by difference, particularly where tax rate determination controller 40 comprises a data link to a database where such information is maintained.

According to another embodiment of the invention where the fuel tax rate takes into consideration an inferred VMT, the tax rate determination controller 40 and pump 50 are cooperatively configured to compute an inferred VMT taking into consideration the quantity of fuel dispensed and the fuel efficiency or average mileage rating for that class of vehicle 90, and then use the inferred VMT to determine the fuel tax rate or amount. In such case, arrow 45 may be more properly depicted as having arrows pointing both directions to more accurately reflect that information is being shared by controller 40 and pump 50 in determining the total amount of fuel tax to be assessed to the purchaser at the POS. It will also be appreciated by the reader of this disclosure that these functions can all be performed by a single PLC that is either resident inside pump 50 or otherwise electronically linked to pump 50.

After fuel is dispensed by pump 50 into vehicle 90 as indicated by arrow 85 of FIG. 1, payment processor 70 receives or calculates and desirably displays the total amount to be charged to and collected from a motor fuel purchaser at the POS. If desired, the base fuel price per unit volume (e.g., $/gal, [symbol] /liter, cents/ft³, cents/Kwh) can be displayed together with the total base fuel price, the applicable tax rate or code, the total tax amount, and the total sales price for the transaction. Payment is desirably processed by payment processor 70 at the POS in the customary fashion, either at the pump or inside a kiosk, gas station or convenience store, for example, with payment being made in any acceptable form, such as cash, check, debit or credit. Payment processor 70 can be integrated into fuel dispensing pump 50 at the POS, and will desirably also have the capability of generating a digital and, optionally, paper record of the payment and other predetermined information relating to the fuel purchase transaction.

Referring again to FIG. 1, information regarding the amount of fuel tax assessed and collected is also desirably forwarded to a payment distribution controller 80 as indicated by arrow 75 for distribution to such predetermined accounts and in accordance with such procedures and controls as may have been established and programmed into system 10.

Examples of motor fuel purchase transactions for different vehicles or circumstances are provided below to illustrate further how various embodiments of the system and method of the invention can be used in motor vehicle fuel purchase transactions to determine, assess and collect fuel taxes:

### EXAMPLE 1

Vehicle A: avg fuel economy is 42 mpg, tax table entry 2, base tax 0.50 cents/gallon, tax table multiplier for tax table entry 2 is 1.25% yielding 0.625 cents/gallon, purchases 10 gallons, pays $6.25 in total gas tax.

### EXAMPLE 2

Vehicle B: avg fuel economy is 22 mpg, tax table entry 7, base tax 0.50 cents/gallon, tax table multiplier for tax table entry 7 is 1.95% yielding 0.975 cents/gallon, purchases 10 gallons, pays $9.75 in total gas tax.

In the two examples provided above, the base price per gallon of motor fuel is desirably posted at the POS. If the motor fuel tax assessment and collection program approved for use in a particular jurisdiction permits, there may be a “default” tax rate that applies in circumstances where, for example and without limitation, a single “default” rate is applied unless otherwise modified or exempted, or a vehicle operator does not have a VID for the vehicle being refueled, or a vehicle operator has not registered and received a purchaser identification number.

### EXAMPLE 3

A motor vehicle is purchased and the owner is issued a VID that includes the VIN. When fuel is purchased, the VID is scanned at the POS and assigns a fuel tax rate according to the vehicle class (e.g., passenger sedan; high performance; SUV; light truck; hybrid; etc.). The fuel dispensing device at the POS adds the appropriate tax (or taxes if both federal and state or federal, state and local fuel taxes are levied) to the base fuel price, and the purchaser is charged for the measured amount of fuel dispensed and the total taxes. When payment is made, the appropriate amounts of tax are distributed to previously designated accounts for the various taxing authorities or agencies.

### EXAMPLE 4

This example is substantially the same as with EXAMPLE 2, except that the fuel tax is based upon inferred VMT rather than other differentiating factors such as, for example, vehicle weight, vehicle cost, or the like. In this case, a base VMT is established by the federal government and is optionally increased by state and/or local governments if permitted. The total VMT includes all applied tax rates, similar to how the gas tax is currently calculated.

### EXAMPLE 5

In this example, the vehicle class tax rate is standardized and regulated by the United States Government based on vehicle class. The vehicle class tax rate is assigned to each vehicle based on the VIN. The vehicle class represents a grouping of similar vehicle miles per gallon ratings. The vehicle class tax rate is determined using factors such as historical VMT per capita, vehicle sales statistics, and federal, state, and local tax burden needs. This approach to establishing applicable tax rates can help create consistency and improve public acceptance.

### EXAMPLE 6

In this example, the vehicle class tax rate is outlined in a VMT class chart. The VMT class chart is posted somewhere on the premises of the POS for purposes of user notification. The driver presents proof of vehicle class tax rate via the VID at the POS and a percentage of discount is applied to the base rate.

Other alternative embodiments of the invention can likewise be similarly configured to reflect other policy objectives or deal with other circumstances that can be reasonably anticipated or otherwise arise. By way of example, and again without limitation, the DMV, DOL, or state vehicle registration facilities/merchants can provide the VID. VID card readers can be configured to simply assign vehicle tax rate to the purchase and not record the POS. The gas price that is displayed on signage can be required to include the highest allowable fuel tax rate as a default tax rate that is charged to purchasers who do not have a valid VID or assigned purchase number. Older fuel d/dispensing stations lacking electronic payment equipment or other equipment needed to implement preferred embodiments of the subject system and method can be required to levy the highest allowable tax rate to encourage them to invest in upgraded equipment or for other purposes. Incrementally higher tax rates can be applied to purchasers who manually input a required user number in view of the higher risk of entering incorrect information in such cases. Alternate IDs can be registered and used to purchase fuel under identified circumstances, perhaps at higher identified tax rates. For compressed gas or electric or hybrid-fueled vehicles, special tax rates may need to be established that take into consideration factors relevant to their implementation and use.

In implementing the system and method of the invention, certain rules, restrictions and business practices may also need to be implemented to avoid compromising the overall objectives of the fuel tax assessment and collection system. Such considerations can include, for example, insisting that the issuance of VIDs be limited to governmental agencies such as state traffic enforcement agencies, and that only one VID be issued per vehicle.

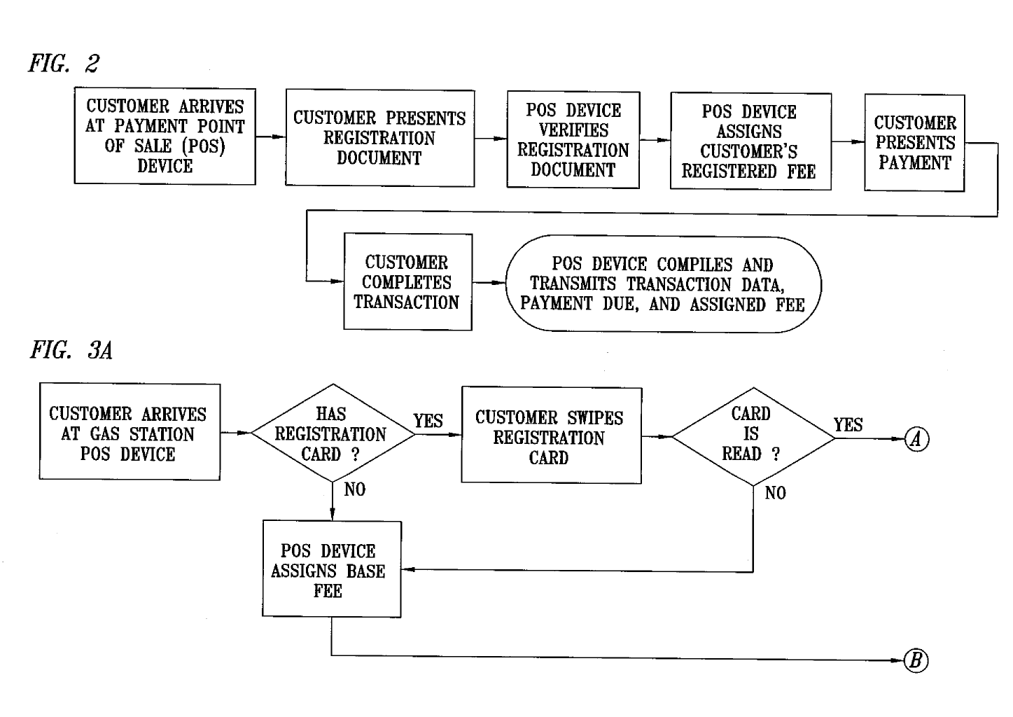

Referring to FIG. 2, a simplified, self-explanatory flowchart is depicted that illustrates the configuration and use of one embodiment of the system and method of the invention in a progression that exemplifies a fuel purchase transaction using the system and method of the invention. As used here, the term “self-explanatory” assumes that the reader is one of ordinary skill in the art who has already read and understands the foregoing text of this application and the system and method of the invention as characterized, explained and discussed in relation to the foregoing Summary and discussion of the embodiment of FIG. 1.

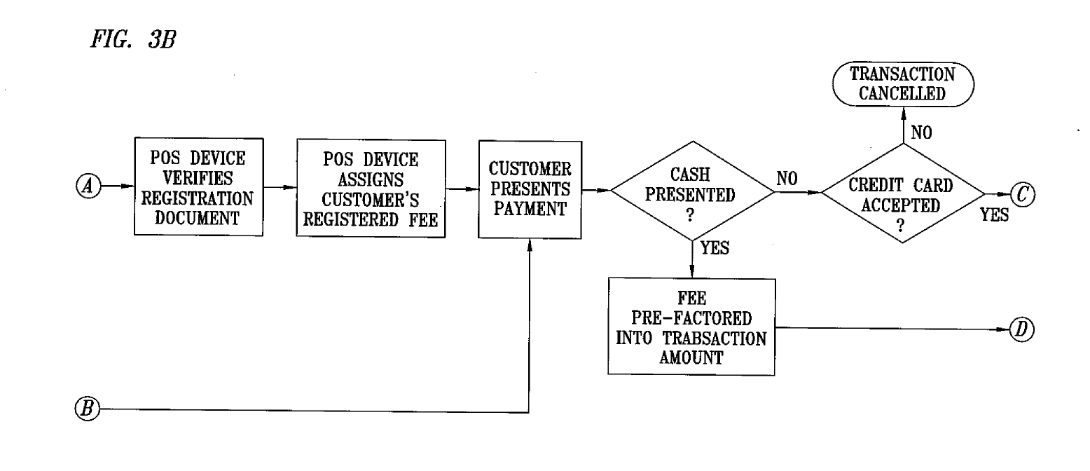

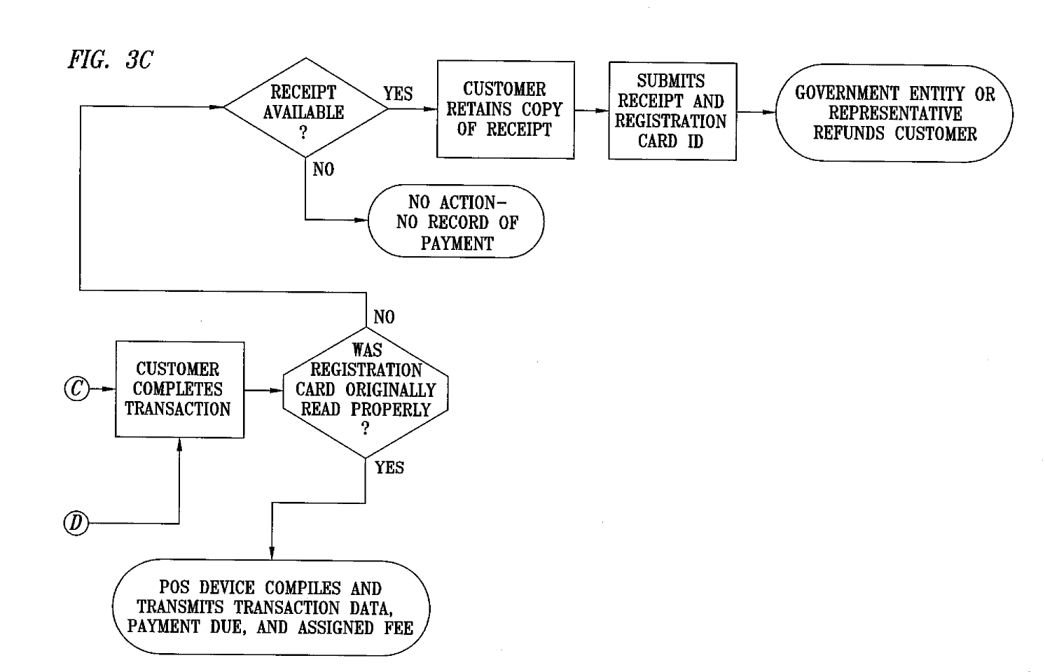

Referring to FIG. 3, a more detailed, self-explanatory flowchart is depicted that illustrates the configuration and use of one embodiment of the system and method of the invention in a progression that exemplifies a fuel purchase transaction using the system and method of the invention.

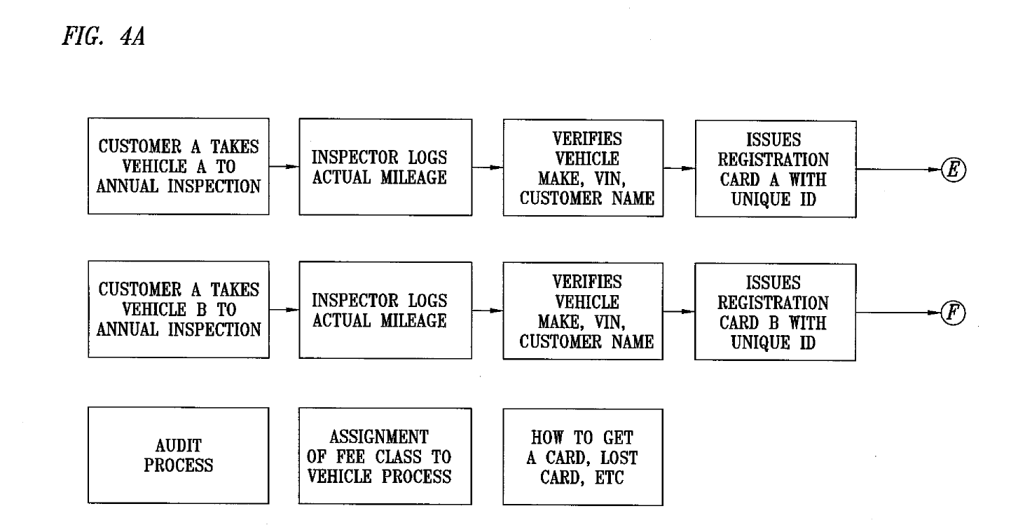

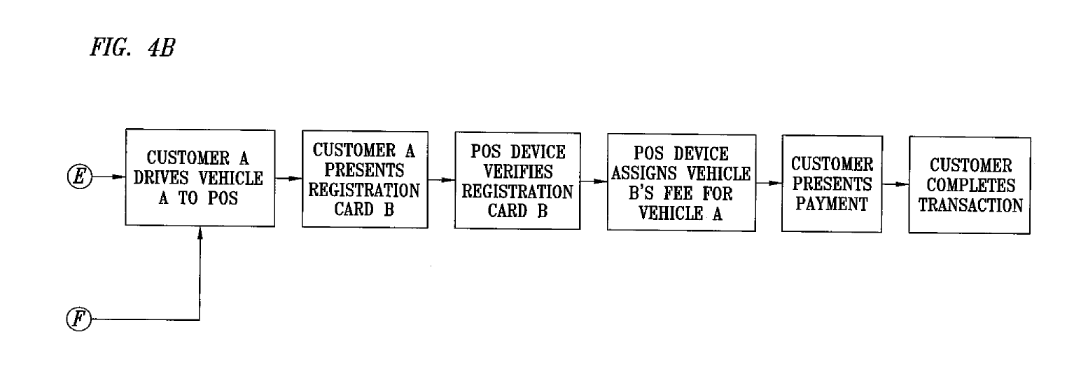

Referring to FIG. 4, an expanded, self-explanatory flowchart is depicted that illustrates another embodiment of the invention wherein an annual vehicle inspection (not required by all states) is used as a reference point at which an existing VID is issued, updated or certified, that verifies the vehicle, owner and mileage and can then optionally be used to link multiple vehicles for purposes of fuel purchase transactions.

Other alterations and modifications of the invention will likewise become apparent to those of ordinary skill in the art upon reading this specification in view of the accompanying drawings, and it is intended that the scope of the invention disclosed herein be limited only by the broadest interpretation of the appended claims to which the inventor(s) and/or Applicant are legally entitled.

What is claimed is:

1. A system for assessing and collecting taxes for motor vehicle fuel at a point of sale for motor fuel, the system comprising:
a vehicle identification device or other input device device useful for inputting identifying information for a vehicle and, optionally, for a user;
a reader or scanner to receive and process information received or obtained from the vehicle identification device;
a tax rate and price determination controller that can determine an appropriate tax rate to be added to a base fuel price;
a dispensing device configured to dispense motor fuel to an identified vehicle and track the quantity of motor fuel dispensed;
a payment processor that can determine a total purchase price including a base fuel component and at least one tax component and execute a payment transaction for a particular method of payment;
and a payment distribution controller that can allocate portions of the total purchase price to an identified account and execute or report such distributions.

2. The system of claim 1 wherein the motor vehicle fuel is gasoline and the dispensing device is a gas pump.

3. The system of claim 1, further comprising a source of vehicle miles traveled.

4. The system of claim 3 wherein the source of vehicle miles traveled provides a record of actual miles traveled by the identified vehicle.

5. A method for assessing and collecting taxes for motor vehicle fuel at a point of sale for motor fuel, the method comprising:
receiving and processing vehicle identification information;
assigning a base price for a selected motor fuel to an identified motor vehicle;
assigning a motor fuel tax rate to the identified motor vehicle;
dispensing motor fuel to the identified motor vehicle at the point of sale;
determining a quantity of motor fuel dispensed to the identified motor vehicle;
calculating a sales price for the quantity of motor fuel dispensed to the motor vehicle;
calculating a tax amount dependent upon the quantity of motor fuel dispensed to the motor vehicle;
combining the sales price and the tax amount to produce a total sales price for the motor fuel;
processing payment for the total sales price;
reporting the motor fuel purchase transaction; and
distributing a portion of the total sales price to at least one designated account associated with a motor fuel taxing authority.

6. The method of claim 5 wherein the motor fuel is gasoline.

7. The method of claim 5 comprising the additional step of determining the vehicle miles traveled by the motor vehicle.

8. The method of claim 5 wherein a number of vehicle miles traveled is inferred.
